(19) United States
(12) Patent Application Publication
(10) Pub. No.: US 2026/0263853 A1
(43) Pub. Date: Sep. 10, 2026

(54) UTILIZING A FIRE HOSE WINDER AND A FIRE HOSE TRAY ON A ROBOTIC FIREFIGHTING VEHICLE

(71) Applicant: Howe & Howe Inc., Waterboro, ME (US)

(72) Inventors: Michael J. Zagorianakos, Buxton, ME (US); Timothy Merlin Foley, Lyman, ME (US); Jesse Morrill, Standish, ME (US); Matthew Gregory Williams, Kennebunk, ME (US)

(21) Appl. No.: 19/555,459

(22) Filed: Mar. 3, 2026

Related U.S. Application Data
(60) Provisional application No. 63/766,660, filed on Mar. 4, 2025.

(51) Int. Cl. A62C 33/02; A62C 27/00; A62C 33/04; B65H 54/02

(52) U.S. Cl. CPC A62C 33/02; A62C 27/00; A62C 33/04; B65H 54/02; B65H 2402/42; B65H 2403/92; B65H 2403/941

(57) ABSTRACT

A robotic firefighting vehicle may be provisioned with fire hose management equipment such as a fire hose winder and/or a fire hose storage assembly. The fire hose winder includes a rotatable assembly which defines a hose space within which a fire hose is wound. The fire hose storage assembly including a hose storage tray constructed and arranged to mount over a horizontal portion of the vehicle, and provide a sloped surface on which a set of fire hoses may rest when the hose storage tray is mounted over the horizontal portion of the robotic firefighting vehicle.

### CROSS REFERENCE TO RELATED APPLICATIONS

This application is a regular utility application based on earlier-filed U.S. Application No. 63/766,660 filed on March 04, 2025, entitled "Utilizing a Fire Hose Winder and a Fire Hose Tray on a Robotic Firefighting Vehicle", the contents and teachings of which are hereby incorporated by reference in their entirety.

### TECHNICAL FIELD

This disclosure relates generally to fire hose equipment, and more particularly to a fire hose winder and a fire hose tray for a vehicle.

### BACKGROUND

Fire hoses include sections of fire hose material and fire hose couplings on the ends of the sections. The sections of the fire hoses are configured to carry water under high pressure, and the fire hose couplings of the fire hoses are configured to connect the fire hoses with other equipment (e.g., mobile firefighting apparatus, tank trucks, hydrants, nozzles, other fire hoses, etc.).

In the context of mobile firefighting apparatus, after the mobile firefighting apparatus move to firefighting areas and the fire hoses are used, firefighters may roll up the fire hoses into coils. The firefighters may then place the coiled fire hoses onto the mobile firefighting apparatus for storage and subsequent reuse.

### BRIEF DESCRIPTION OF THE DRAWINGS

The foregoing and other objects, features and advantages will be apparent from the following description of particular embodiments of the present disclosure, as illustrated in the accompanying drawings in which like reference characters refer to the same parts throughout the different views. The drawings are not necessarily to scale, emphasis instead being placed upon illustrating the principles of various embodiments of the present disclosure.

FIG. 1 is a perspective view of an example robotic firefighting vehicle equipped with a fire hose winder and a fire hose storage assembly in accordance with one or more embodiments.

FIG. 2 is a perspective view of the example robotic firefighting vehicle simply with the fire hose winder in accordance with one or more embodiments.

FIG. 3 is a perspective view of the example robotic firefighting vehicle simply with the fire hose storage assembly in accordance with one or more embodiments.

FIG. 4 is a perspective view of the example robotic firefighting vehicle with the fire hose winder and the fire hose storage assembly while managing fire hoses in accordance with one or more embodiments.

FIG. 5 is an exploded view of an example motorized fire hose winder for a vehicle in accordance with one or more embodiments.

FIG. 6 is a reverse angle exploded view of the example motorized fire hose winder in accordance with one or more embodiments.

FIG. 7 is an exploded view of an example mechanical fire hose winder for a vehicle in accordance with one or more embodiments.

FIG. 8 is a reverse angle exploded view of the example mechanical fire hose winder in accordance with one or more embodiments.

FIG. 9 is an exploded view of the example robotic firefighting vehicle and the fire hose storage assembly in accordance with one or more embodiments.

FIG. 10 a reverse angle exploded view of the example robotic firefighting vehicle equipped and the fire hose storage assembly in accordance with one or more embodiments.

### DETAILED DESCRIPTION

In typical mobile firefighting apparatus use cases, firefighters roll up fire hoses into coils after use, and then place the coiled fire hoses directly onto the mobile firefighting apparatus for storage and subsequent reuse. However, firefighters often find the tasks of rolling up fire hoses into coils after use to be tedious and difficult if the firefighters manually roll up the fire hoses. Alternatively, some conventional mechanical fire hose coiling mechanisms exist, but such mechanical coiling mechanisms are complex and/or awkward to use (e.g., by requiring the fire hoses to be fed through separate frontend hose guides before forming coils, by requiring firefighters to carefully tend to the fire hoses such as by pushing sideways on the fire hoses as the fire hoses are being coiled to avoid inadvertent unraveling off the sides of the mechanisms during the coiling process, etc.).

Additionally, once fire hoses are coiled, placement of the coiled fire hoses directly onto the mobile firefighting apparatus has deficiencies. For example, such coiled fire hoses may easily fall off the mobile firefighting apparatus and perhaps sustain damage as the mobile firefighting apparatus tilt, turn, shifts weight, etc. while moving. As another example, when fire hoses are placed on mobile firefighting apparatus, the fire hose couplings may scratch and remove paint, finishes, protective coatings, etc. of the mobile firefighting apparatus making the mobile firefighting apparatus more susceptible to corrosion, etc. As yet another example, due to protrusions, sharp edges, etc. from various features on the mobile firefighting apparatus, fire hoses may get caught (e.g., snagged, punctured, fractured, otherwise damaged, etc.) as the fire hoses are removed from the mobile firefighting apparatus (e.g., as the fire hoses are quickly put into use during emergency events).

Unfortunately, as described above, conventional approaches to coiling fire hoses, directly placing coiled fire hoses onto mobile firefighting apparatus, and removing coiled fire hoses from mobile firefighting apparatus suffer from various drawbacks. What is needed, therefore, is a way to effectively manage fire hoses utilized with vehicles.

The above need is addressed at least in part by a fire hose winder and a fire hose tray for a firefighting vehicle. Along these lines, such firefighting equipment may be installed on a robotic firefighting vehicle to facilitate fire hose management. In some arrangements, a fire hose winder includes a rotatable assembly (e.g., a fire hose spindle or drum structure) that defines a fire hose space within which a fire hose is wound thus alleviating the need for complex and/or awkward fire hose coiling mechanisms (e.g., conventional mechanisms which require fire hoses to be fed through separate frontend hose guides before forming coils, conventional mechanisms which require someone to push sideways on the fire hoses as fire hoses are being coiled to avoid inadvertent unraveling during the coiling process, etc.). In some arrangements, a fire hose tray mounts over a portion of a vehicle and provides (or includes) an inwardly sloping surface on which a wound fire hose may rest thus preventing the fire hose from damaging the vehicle (e.g., during placement of the fire hose onto the vehicle), preventing the fire hose from falling off the vehicle and/or sustaining damage itself (e.g., while the vehicle is moving), and/or preventing damage to the fire hose (e.g., eliminating opportunities for snagging/catching as the fire hose is quickly removed from the vehicle for use), and so on.

The various individual features of the particular arrangements, configurations, and embodiments disclosed herein can be combined in any desired manner that makes technological sense. Additionally, such features are hereby combined in this manner to form all possible combinations, variants and permutations except to the extent that such combinations, variants and/or permutations have been expressly excluded or are impractical. Support for such combinations, variants and permutations is considered to exist in this document.

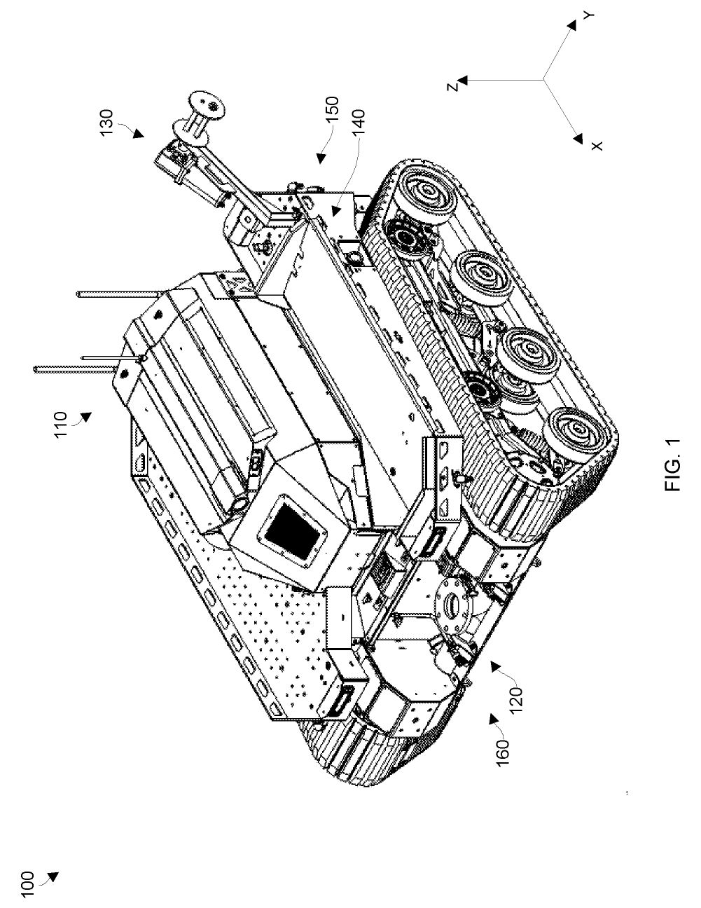

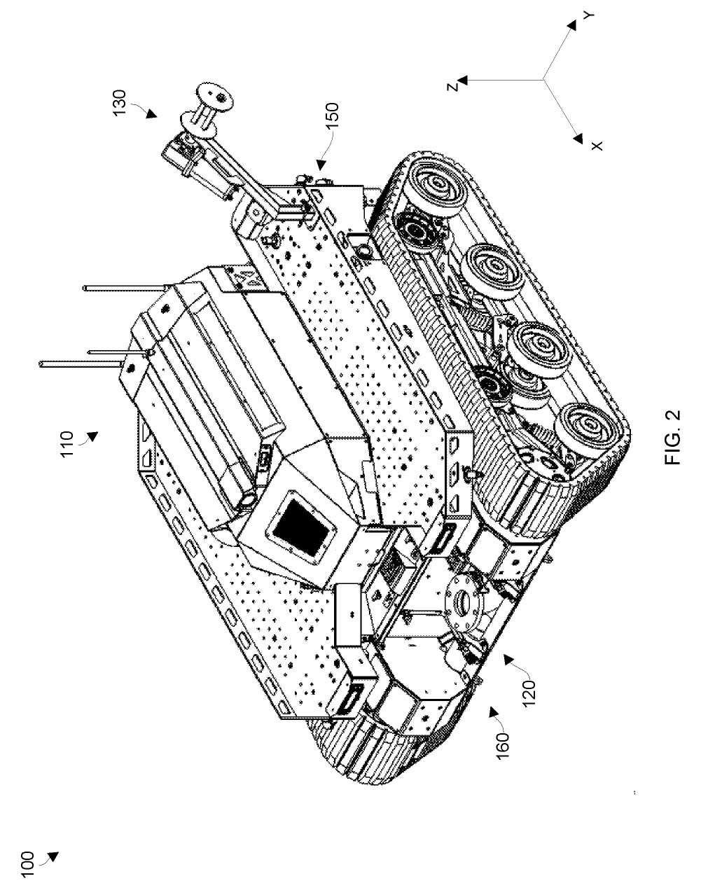

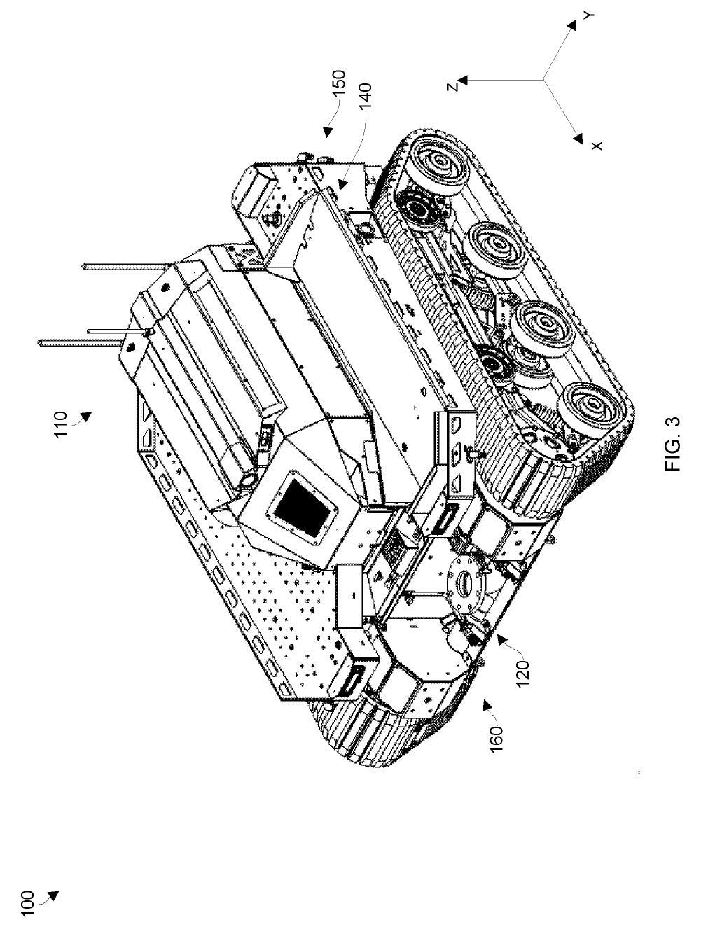

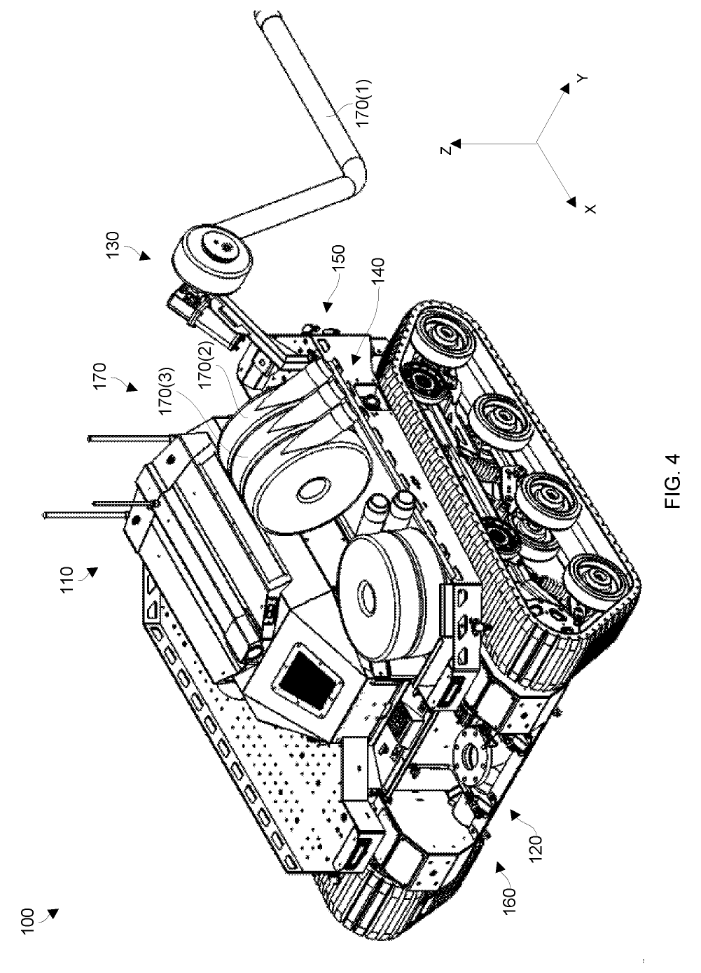

FIGS. 1 through 4 show an example robotic firefighting vehicle 100 in accordance with one or more embodiments. FIG. 1 shows the example robotic firefighting vehicle equipped with a fire hose winder and a fire hose storage assembly. FIG. 2 shows the example robotic firefighting vehicle simply with the fire hose winder. FIG. 3 shows the example robotic firefighting vehicle simply with the fire hose storage assembly. FIG. 4 shows the example robotic firefighting vehicle equipped with the fire hose winder and the fire hose storage assembly while managing fire hoses.

As best seen in FIG. 1, the example robotic firefighting vehicle 100 includes a robotic firefighting vehicle body 110, a fluid delivery system 120, a fire hose winder 130, and a fire hose storage assembly 140. In accordance with certain embodiments, the fire hose storage assembly 140 is omitted from the robotic firefighting vehicle 100 (but could be added at a later time, e.g., see FIG. 2). Similarly, in accordance with certain embodiments, the fire hose winder 130 is omitted from the robotic firefighting vehicle 100 (but could be added at a later time, e.g., see FIG. 3).

The robotic firefighting vehicle body 110 of the robotic firefighting vehicle 100 is constructed and arranged to robotically maneuver within an environment. Along these lines, the robotic firefighting vehicle body 110 may have a configuration in which a set of fire hoses (i.e., one or more fire hoses) can connect to a back portion 150 of the robotic firefighting vehicle body 110 and in which a set of fire monitors (i.e., one or more fire monitors) can connect to a front portion 160 of the robotic firefighting vehicle body 110. With this configuration, the set of fire hoses is able to supply fluid (e.g., water) from the back portion 150 to the front portion 160 for delivery through the set of fire monitors. Such a configuration enables high capacity fluid delivery even while the robotic firefighting vehicle 100 is moving. Nevertheless, it should be understood that other locations of the robotic firefighting vehicle body 110 are suitable as well for connecting one or more fire hoses and one or more fire monitors.

Additionally, the robotic firefighting vehicle body 110 may serve as a useful robotic firefighting platform which is maneuverable over various types of terrains by an operator at a safe distance from one or more burning targets. For example, the robotic firefighting vehicle body 110 may have the form factor of a tracked vehicle making the robotic firefighting vehicle 100 capable of traversing a variety of environments such as fields, hills, ditches, dunes, marshes, rough terrains, roadways, runways, and so on. Other ground engaging equipment is suitable for use as well such as tires/wheels, skis, additional tracks, combinations thereof, etc.).

Furthermore, the robotic firefighting vehicle body 110 may include other structures and/or systems. Along these lines, the robotic firefighting vehicle body 110 may support equipment such as a propulsion system (e.g., a set of combustion engines and/or electric motors, fuel/power sources, transmissions, brakes, etc.), a control system (e.g., a steering subsystem, actuators, sensors, controllers, wireless communications equipment, etc.), cargo carriers (e.g., baskets, racks, tanks, etc.), winches/towing equipment, cameras, lights, and so on.

The fluid delivery system 120 is supported by the robotic firefighting vehicle body 110, and is constructed and arranged to deliver fluid from the set of fire hoses to the set of fire monitors. Along these lines, the fluid delivery system 120 may include a fluid manifold for conveying fluid in high volume. For example, in a front-to-back configuration, such a fluid manifold may intake fluid from the back portion 150 and convey the fluid to the front portion 160 through the robotic firefighting vehicle body 110 for delivery of the fluid to one or more targets via one or more fire monitors.

The fire hose winder 130 is supported by the robotic firefighting vehicle body 110. FIGS. 1, 2, and 4 show how the fire hose winder 130 may be mounted onto the robotic firefighting vehicle body 110 of the robotic firefighting vehicle 100.

The fire hose winder 130 is constructed and arranged to wind a fire hose. Along these lines and as will be explained in further detail shortly, a portion of the fire hose winder 130 defines a fire hose space within which the fire hose is wound thus alleviating the need to feed the fire hose through a separate frontend hose guide before forming a coil. Additionally, the portion of the fire hose winder 130 that defines the fire hose space has retention features which inhibit the fire hose from inadvertently unraveling during the coiling process.

In some arrangements, the fire hose winder 130 is driven by a motor (e.g., via electric power). Such a fire hose winder 130 alleviates the need for a firefighter to manually wind the fire hose.

In some arrangements, the fire hose winder 130 is manually turned (e.g., via handle or lever). Such a fire hose winder 130 alleviates the need for an electric power source to drive the fire hose winder 130.

In some arrangements, the fire hose winder 130 is able to be driven by a motor or may be manually turned. Such a fire hose winder 130 provides the option of automated winding or manual winding for maximum flexibility.

As best seen in FIG. 2, the robotic firefighting vehicle 100 may simply include the fire hose winder 130 (e.g., the fire hose storage assembly 140 may be omitted). Advantageously, the robotic firefighting vehicle 100 is able to effectively and efficiently wind a fire hose without requiring extensive time and effort from a firefighter.

Similarly, the fire hose storage assembly 140 is supported by the robotic firefighting vehicle body 110. FIGS. 1, 3, and 4 show how the fire hose storage assembly 140 may be mounted onto the robotic firefighting vehicle body 110 of the robotic firefighting vehicle 100.

The fire hose storage assembly 140 is constructed and arranged to protect the robotic firefighting vehicle 100 and fire hoses stored thereon. Along these lines and as will be explained in further detail shortly, the fire hose storage assembly 140 provides (or includes) a sloped surface on which fire hoses may rest to inhibit the fire hoses from falling off while the robotic firefighting vehicle 100 is moving. That is, any fire hoses resting on the sloped surface will have their weight shifted (or lean) toward the inner region of the robotic firefighting vehicle body 110.

Additionally, the fire hose storage assembly 140 provides protective surfaces which prevent the fire hoses from damaging the robotic firefighting vehicle 100. Along these lines, the protective surfaces prevent scratching/scraping against the robotic firefighting vehicle body 110 as well as prevent damage to the fire hoses (e.g., reducing or eliminating the opportunities for the fire hoses to catch/snag on sharp edges, etc.).

As best seen in FIG. 3, the robotic firefighting vehicle 100 may simply include the fire hose storage assembly 140 (e.g., the fire hose winder 130 may be omitted). Advantageously, the robotic firefighting vehicle 100 is able to effectively and efficiently store a set of fire hoses in a well-organized and protective manner.

As best seen in FIG. 4, when the robotic firefighting vehicle 100 is equipped with both the fire hose winder 130 and the fire hose storage assembly 140, the robotic firefighting vehicle 100 is able to effectively and efficiently wind and store fire hoses 170(1), 170(2), 170(3), … (collectively, fire hoses 170). Along these lines, the fire hose winder 130 is currently winding the fire hose 170(1). In particular, a coupling of an initially uncoiled fire hose 170(1) may simply be disconnected from the back portion 150 of the robotic firefighting vehicle body 110 and loaded into the fire hose winder 130 which then winds the fire hose 170(1) into a coiled arrangement.

Additionally, once a fire hose 170 is wound, the fire hose 170 is placed onto the fire hose storage assembly 140. Along these lines, the fire hose storage assembly 140 prevents the wound fire hoses 170 from falling off the robotic firefighting vehicle 100 and from damaging the surfaces of the robotic firefighting vehicle 100.

Furthermore, the fire hose storage assembly 140 maintains the wound fire hoses 170 in their stowed formation even if the robotic firefighting vehicle 100 is moving. Along these lines and as shown in FIG. 4, the fire hoses 170 may be placed in an upright side-by-side arrangement (e.g., see the fire hoses 170(2) and 170(3) in FIG. 4). Alternatively or in addition, the fire hoses 170 may be stacked in a pancaked manner one on top of the other. Such arrangements may be employed based on preference (e.g., for storage efficiency, based on the particular features of the fire hoses 170, based on how quickly the fire hoses 170 may be removed and put back into use during an emergency, etc.).

Also, the fire hose storage assembly 140 allows the fire hoses 170 to be quickly taken off the robotic firefighting vehicle 100. Along these lines, the protective surfaces provided by the fire hose storage assembly 140 prevent the fire hoses 170 from catching, snagging, etc. when the fire hoses 170 are pulled/pushed/lifted/etc. off of the robotic firefighting vehicle 100.

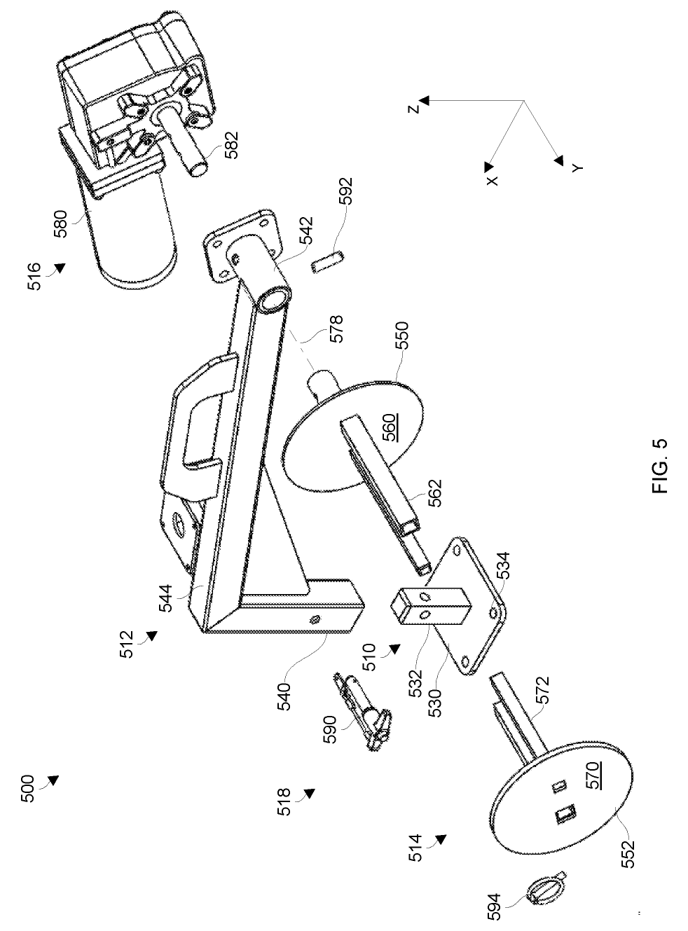

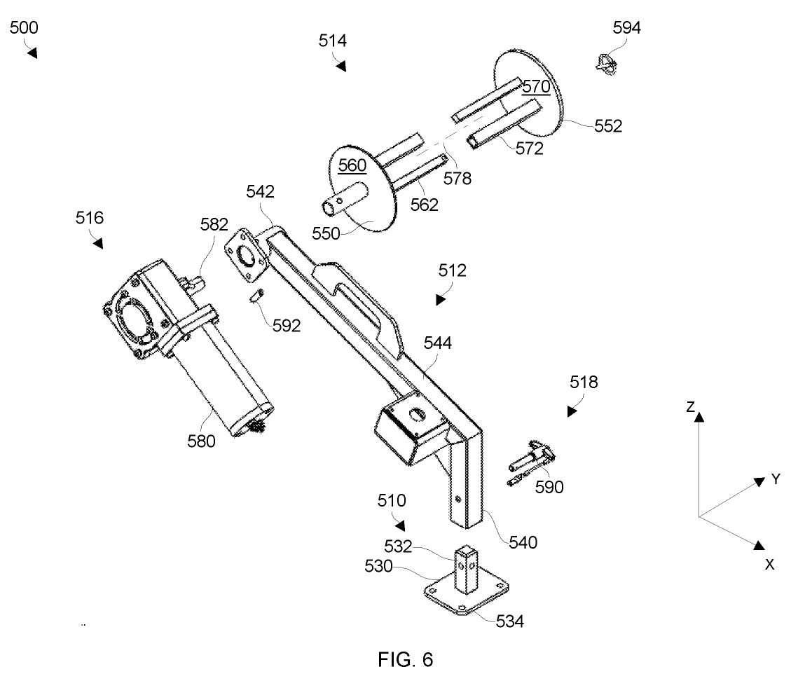

In some arrangements, the fire hose winder 130 and the fire hose storage assembly 140 are mounted to the same side of the robotic firefighting vehicle 100 (e.g., the left side, the right side, etc.). Accordingly, an operator may quickly remove a wound fire hose 170 from the fire hose winder 130 and place that fire hose 170 onto the fire hose storage assembly 140 perhaps to then wind another fire hose 170. Such an arrangement, alleviates the need for operator carry a wound fire hose 170 around the robotic firefighting vehicle 100 or to another location, and so on. Further details will now be provided with reference to FIGS. 5 and 6.

FIGS. 5 and 6 show certain features of an example motorized fire hose winder 500 in accordance with one or more embodiments. FIG. 5 is an exploded view of the example motorized fire hose winder 500. FIG. 6 is a reverse angle exploded view of the example motorized fire hose winder 500.

The example motorized fire hose winder 500 is suitable for use as the fire hose winder 130 which is mounted onto the robotic firefighting vehicle body 110 of the robotic firefighting vehicle 100 (e.g., also see FIGS. 1, 2, and 4). Along these lines, the example motorized fire hose winder 500 includes a mounting bracket 510, an arm 512, a rotatable assembly 514, a motor 516, and hardware 518.

The mounting bracket 510 is constructed and arranged to mount to a robotic firefighting vehicle body of a robotic firefighting vehicle (e.g., see FIGS. 1 through 4). Along these lines, the mounting bracket 510 includes a vehicle mounting plate 530 constructed and arranged to mount to the vehicle and a pillar 532 which extends outward from the mounting plate 530. For example, the robotic firefighting vehicle body may provide a horizontal mounting surface that extends along the X-Y plane, and the vehicle mounting plate 530 may similarly extend along the X-Y plane to enable the vehicle mounting plate 530 to sit flush against the robotic firefighting vehicle body (FIG. 5). Additionally, the vehicle mounting plate 530 may define a set of mounting holes 534 through which a set of bolts (or similar hardware) may extend to engage a set of threaded holes defined by the robotic firefighting vehicle body to fasten the vehicle mounting plate 530 to the robotic firefighting vehicle body.

The pillar 532 then extend outward from a center of the mounting plate 530 (FIG. 5). For example, if the mounting plate 530 extends in the X-Y plane, the pillar 532 may extend upwardly from the mounting plate 530 in the positive Z-direction.

The arm 512 includes a first end 540, a second end 542, and a middle section 544. The first end 540 is constructed and arranged to couple with the mounting bracket 510. The second end 542, which is opposite the first end 540, is constructed and arranged to couple with the rotatable assembly 514. The middle section 544 has at least a predefined length to enable the rotatable assembly 514 to have enough clearance from the firefighting vehicle body to enable effective and efficient fire hose winding without the fire hose being impeded by the firefighting vehicle body during the winding process (e.g., see FIG. 4).

The arm 512 may include other features as well. For example, the arm 512 may include a hand grip to enable the arm 512 to be easily lifted up and down during arm installation and/or de-installation. As another example, the arm 512 may include attachment or support features which enable securing of the rotatable assembly 514 and/or the motor 516 to the arm 512, and so on.

As shown in FIGS. 5 and 6, the pillar 532 may extend outwardly from the vehicle mounting plate 530 of the mounting bracket 510 (e.g., in the positive Z-direction) by a predefined amount for engagement with the arm 512. Along these lines, the first end 540 of the arm 512 may define a hollow channel to receive the pillar 532.

In some arrangements, the pillar 532 of the mounting bracket 510 and the hollow channel defined by the first end 540 of the arm 512 have rectangular cross-sections to prevent the arm 512 from inadvertently turning relative to the mounting bracket 510. Accordingly, the example motorized fire hose winder 500 will remain properly aimed at a fire hose when the fire hose is being wound by the motorized fire hose winder 500 (e.g., also see FIG. 4).

The rotatable assembly 514 is constructed and arranged to rotate to wind a fire hose. Along these lines, the rotatable assembly 514 includes a first rotatable side member 550 constructed and arranged to rotatably couple with the second end 542 of the arm 512 (e.g., about the Y-axis) and a second rotatable side member 552 constructed and arranged to engage with the first rotatable side member 550.

The first rotatable side member 550 includes a first side section 560 and a set of first posts 562 extending (e.g., in the positive Y-direction) from the first side section 560. Similarly, the second rotatable side member 552 includes a second side section 570 and a set of second posts 572 extending (e.g., in the negative Y-direction) from the second side section 570.

When the rotatable side members 550, 552 are engaged with each other, the side sections 560, 570 define a fire hose space around the post sets 570, 572. Along these lines, the side sections 560, 570 remain a separated distance from each other and prevent the fire hose from escaping from the rotatable assembly 514 as the fire hose is being coiled. Accordingly, there is no need for a frontend hose guide that would otherwise add complexity to the example motorized fire hose winder 500 and the winding process.

In some situations, the side sections 560, 570 may extend outwardly (or radially) to fully flank a completely wound fire hose. In other situations (e.g., when the fire hose is relatively long), the side sections 560, 570 extend at least partly out to flank a fire hose at the onset of winding but may not fully flank a completely wound fire hose.

In some embodiments, the set of first posts 562 engages with the set of second posts 572 in an interlocking (or sleeved) manner. For example, each side member 550, 552 may include at least one post which joins with a corresponding post of the other side member 550, 552. In such embodiments, an end of a fire hose may be inserted through a gap between the posts (e.g., FIG. 6) to secure the end to the rotatable assembly 514 prior to winding. Then, during winding, the end of the fire hose rotates as the rotatable assembly 514 rotates to wind the fire hose. After the fire hose is wound, the rotatable side member 552 is separated from the rotatable side member 550 and the coiled fire hose is easily slipped off the rotatable side member 550 while remaining coiled. Such a process may be repeated to wind multiple fire hoses.

It should be appreciated that while the rotatable side member 550, 552 of the rotatable assembly 514 are engaged, the rotatable side member 550, 552 are able to rotate in unison about an axis of rotation 578 (e.g., around a Y-axis). In some arrangements, each first post 562 of the set of first posts 562 extends from the first side section 560 in a direction along the axis of rotation 578 toward the second rotatable side member 570, and each second post 572 of the set of second posts 572 extends from the second side section 570 in a direction along the axis of rotation 578 toward the first rotatable side member 550.

The motor 516 is constructed and arranged to rotate the rotatable assembly 514 about the axis of rotation 578. Along these lines, the motor 516 includes a housing 580 and a rotor 582. The motor 516 may include other components as well (e.g., a stator, gears, etc.). The housing 580 attaches to the arm 512 (e.g., via the hardware 518, tabs, combinations thereof, etc.), and the rotor 582 attaches to the rotatable side member 550 of the rotatable assembly 514 (e.g., via the hardware 518, via a sleeve of the rotatable side member 550, combinations thereof, etc.).

The motor 516 may be controlled by a set of switches (e.g., ON/OFF, forward/reverse, slow/fast, combinations thereof, etc.) and operate using electric power supplied by circuitry on or in the firefighting vehicle body.

It should be understood that the motor 516 alleviates the need for a human to manually wind a fire hose and instead rely on the motor 516 to provide sufficient force to properly wind the fire hose. Moreover, the motor 516 may wind the fire hose at an optimized speed (not too fast or slow) thus balancing winding speed with draining time (e.g., time for water to be expressed out of and drain from the fire hose). In some arrangements, the motor 516 may provide a torque release (or clutch) mechanism to prevent the motor 516 from applying excessive pulling force on the fire hose to prevent fire hose damage.

The hardware 518 is constructed and arranged to facilitate assembly and/or disassembly of portions of the motorized fire hose winder 500. Such hardware may include screws, bolts, nuts, pins, springs, grips, tabs, rings, combinations thereof, etc.).

For example, in some embodiments, the hardware 518 includes a locking pin 590 which locks the arm 512 to the mounting bracket 510. While the locking pin 590 is in place through the first end 540 of the arm 512 and the pillar 532 of the mounting bracket 510 (e.g., via insertion), the arm 512 is securely fastened to the mounting bracket 510 (and the vehicle body, e.g., see FIG. 1). However, to remove the arm 512, the locking pin 590 is simply withdrawn from (e.g., slid out of) the first end 540 of the arm 512 and the pillar 532 of the mounting bracket 510.

In some arrangements, the pillar 532 of the mounting bracket 510 may define multiple pin channels (or bores) to receive the locking pin 590. For example, the pillar 532 may define a first pin channel along the X-axis to aim the arm 512 in the negative X-direction to wind a fire hose off of the back of the vehicle body. Additionally, the pillar 532 may define a second pin channel along the Y-axis to aim the arm 512 in the positive Y-direction to wind a fire hose that is more or less perpendicular to the front-back of the vehicle body, and so on. Such a multiple pin channel feature may be particularly well-suited for applications in which fire hoses lead to the vehicle from different directions since the operator may be able to wind the fire hoses without needing to move/re-orient the vehicle (e.g., by quickly disconnecting the arm 512, pointing the arm 512 in a different direction and re-attaching the arm 512, etc.).

In an example use case, the arm 512 is oriented such that it points toward the front of the vehicle (e.g., see the vehicle front 160 in FIG. 1) to enable the fire hose winder 500 to reside in a stowed configuration in which the second end 542 of the arm 512 and the rotatable assembly 514 are not overhanging the side or the back of the vehicle. Then, to transition the fire hose winder 500 into an optimized operational configuration, the arm 512 is easily detached from the mounting bracket 510 and reattached to the mounting bracket 510 at a different orientation via the removing and replacing the locking pin 590.

As another example, in some embodiments, the hardware 518 includes a locking pin 592 which locks the rotatable assembly 514 to the arm 512 and/or the motor 516. Along these lines, the locking pin 592 may insert through the rotatable side member 550 and the rotor 582 to enable the rotatable side member 550 to be captured by the second end 542 of the arm 512 and to enable the rotatable side member 550 and the rotor 582 to rotate together.

As yet another example, in some embodiments, the hardware 518 includes a locking pin 594 which locks the rotatable side members 550, 552 together. Along these lines, a first post 562 of the rotatable side member 550 may extend through a corresponding second post 572 and the side section 570 of the rotatable side member 552 when the rotatable side members 550, 552 are engaged with each other. The locking pin 594 then inserts through a protruding end of the first post 562 to lock the rotatable side members 550, 552 together. A user may perform this step prior to fire hose winding, and may easily remove the pin 594 and the rotatable side member 552 after fire hose winding to remove the fire hose from the rotatable assembly 514.

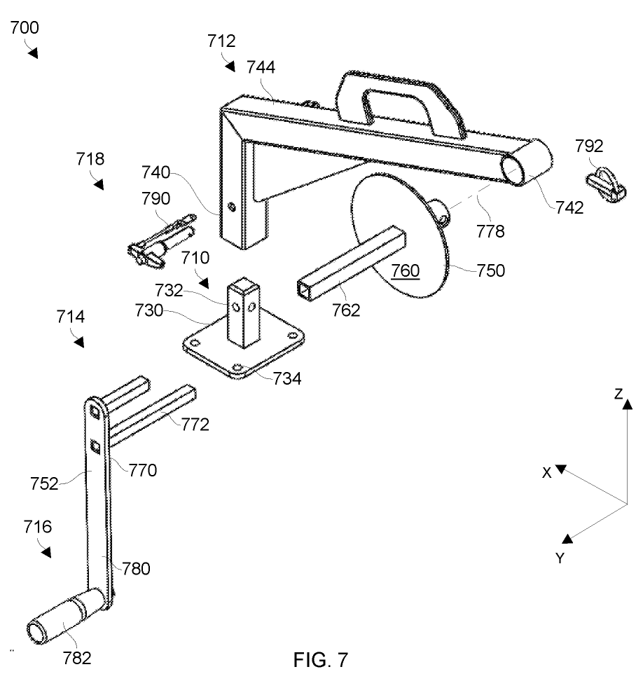

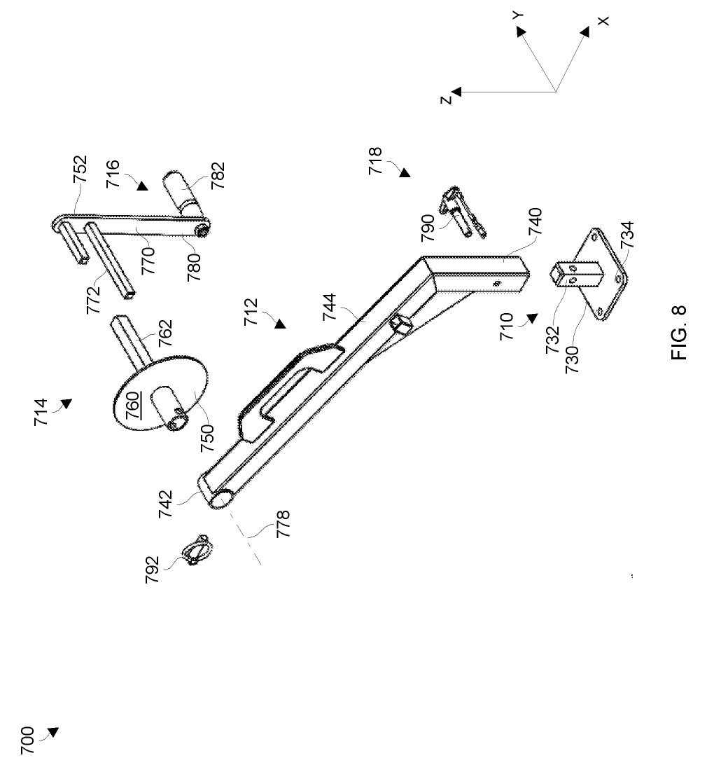

Other hardware is suitable for use as well with the motorized fire hose winder 500. Further details will now be provided with reference to FIGS. 7 and 8.

FIGS. 7 and 8 show certain features of an example mechanical (or lever-driven) fire hose winder 700 in accordance with one or more embodiments. FIG. 7 is an exploded view of the example mechanical fire hose winder 700. FIG. 8 is a reverse angle exploded view of the example mechanical fire hose winder 700.

The example mechanical fire hose winder 700 is similar to the example motorized fire hose winder 500 and is suitable for use as the fire hose winder 130 which is mounted onto the robotic firefighting vehicle body 110 of the robotic firefighting vehicle 100 (e.g., also see FIGS. 1, 2, and 4). Along these lines, the example mechanical fire hose winder 700 includes a mounting bracket 710, an arm 712, a rotatable assembly 714, a lever (or handle portion) 716, and hardware 718.

The mounting bracket 710 is constructed and arranged to mount to a robotic firefighting vehicle body of a robotic firefighting vehicle (e.g., see FIGS. 1 through 4). Along these lines, the mounting bracket 710 is similar to the mounting bracket 510 (e.g., see FIGS. 5 and 6) in that the mounting bracket 710 includes a vehicle mounting plate 730 constructed and arranged to mount to the vehicle and a pillar 732 which extends outward from the mounting plate 730. For example, the robotic firefighting vehicle body may provide a horizontal mounting surface that extends along the X-Y plane, and the vehicle mounting plate 730 may similarly extend along the X-Y plane to enable the vehicle mounting plate 730 to sit flush against the robotic firefighting vehicle body (FIG. 7). Additionally, the vehicle mounting plate 730 may define a set of mounting holes 734 through which a set of bolts (or similar hardware) may extend to engage a set of threaded holes defined by the robotic firefighting vehicle body to fasten the vehicle mounting plate 730 to the robotic firefighting vehicle body.

The pillar 732 then extend outward from a center of the mounting plate 730 (FIG. 7). For example, if the mounting plate 730 extends in the X-Y plane, the pillar 732 extends upwardly from the mounting plate 730 in the positive Z-direction.

The arm 712 is similar to the arm 512 (e.g., see FIGS. 5 and 6) in that the arm 712 includes a first end 740, a second end 742, and a middle section 744. The first end 740 is constructed and arranged to couple with the mounting bracket 710. The second end 742, which is opposite the first end 740, is constructed and arranged to couple with the rotatable assembly 714. The middle section 744 has at least a predefined length to enable the rotatable assembly 714 to have enough clearance from the firefighting vehicle body to enable effective and efficient fire hose winding without the fire hose being impeded by the firefighting vehicle body during the winding process (e.g., see FIG. 4).

The arm 712 may include other features as well. For example, the arm 712 may include a hand grip to enable the arm 712 to be easily lifted up and down during arm installation and/or de-installation. As another example, the arm 712 may include attachment or support features which enable securing of the rotatable assembly 714 to the arm 712, and so on.

As shown in FIGS. 7 and 8, the pillar 732 may extend outwardly from the vehicle mounting plate 730 of the mounting bracket 710 (e.g., in the positive Z-direction) by a predefined amount for engagement with the arm 712. Along these lines, the first end 740 of the arm 712 may define a hollow channel to receive the pillar 732.

In some arrangements, the pillar 732 of the mounting bracket 710 and the hollow channel defined by the first end 740 of the arm 712 have rectangular cross-sections to prevent the arm 712 from inadvertently turning relative to the mounting bracket 710. Accordingly, the example mechanical fire hose winder 700 will remain properly aimed at a fire hose when the fire hose is being wound by the motorized fire hose winder 700.

The rotatable assembly 714 is constructed and arranged to rotate to wind a fire hose. Along these lines, the rotatable assembly 714 includes a first rotatable side member 750 constructed and arranged to rotatably couple with the second end 742 of the arm 712 (e.g., about the Y-axis) and a second rotatable side member 752 constructed and arranged to engage with the first rotatable side member 750.

The first rotatable side member 750 includes a first side section 760 and a set of first posts 762 extending from the first side section 760. Similarly, the second rotatable side member 752 includes a second side section 770 and a set of second posts 772 extending from the second side section 770.

When the rotatable side members 750, 752 are engaged with each other, the side sections 760, 770 define a fire hose space around the post sets 770, 772. Along these lines, the side sections 760, 770 remain a separated distance from each other and prevent at least a portion of the fire hose from escaping from the rotatable assembly 714 as the fire hose is being coiled. Accordingly, there is no need for a frontend hose guide that would otherwise add complexity to the example mechanical fire hose winder 700 and the winding process.

In some embodiments, the set of first posts 762 engages with the set of second posts 772 in an interlocking (or sleeved) manner. For example, each side member 750, 752 may include at least one post, and that post joins with a corresponding post of the other side member 750, 752. With this embodiment, an end of a fire hose may be inserted through a gap between posts (e.g., FIG. 8) to secure the end to the rotatable assembly 714 prior to winding. Then, during winding, the end of the fire hose rotates as the rotatable assembly 714 rotates to wind the fire hose. Once the fire hose is wound, the rotatable side member 752 is separated from the rotatable side member 750 and the coiled fire hose is easily slipped off the rotatable side member 750 while remaining coiled. Such a process may be repeated to wind multiple fire hoses.

It should be appreciated that while the rotatable side member 750, 752 of the rotatable assembly 714 are engaged, the rotatable side member 750, 752 are able to rotate in unison about an axis of rotation 778 (e.g., the Y-axis). In some arrangements, the first rotatable side member 750 includes exactly one first post 762 which extends from the first side section 760 and is coaxial with the axis of rotation 778, and the second rotatable side member 752 includes exactly two second posts 772, one of which joins with the first post 762.

The lever 716 is constructed and arranged to rotate the rotatable assembly 714 about the axis of rotation 778. Along these lines, the lever 716 includes a handle portion 780 and a rotatable grip 782.

The rotatable grip 782 is constructed and arranged to rotate relative to the handle portion 780 enabling a human user to rotate the lever 716 without having to release the rotatable grip 782. Such a feature is well suited for an operator wearing gloves, having a tight grip just with one hand, and so on.

In some arrangements, the lever 716 is an extension of the second side section 770 of the rotatable side member 752. In other arrangements, the lever 716 and the second side section 770 are separate members which may be coupled with each other (e.g., via hardware).

It should be understood that the lever 716 alleviates the need for a motor and may instead rely on simple leverage (e.g., turning by a human) to provide sufficient force to properly wind the fire hose. Moreover, the lever 716 enables a human to control the winding force without requiring electric controls. In some arrangements, the lever 716 may provide a torque release (or clutch) mechanism to prevent the lever 716 from applying excessive pulling force on the fire hose to prevent fire hose damage.

The hardware 718 is similar to the hardware 518 (e.g., see FIGS. 5 and 6) is constructed and arranged to facilitate assembly and/or disassembly of portions of the motorized fire hose winder 700. Such hardware may include screws, bolts, nuts, pins, springs, grips, tabs, rings, combinations thereof, etc.).

For example, in some embodiments, the hardware 718 includes a locking pin 790 which locks the arm 712 to the mounting bracket 710. While the locking pin 790 is inserted within the first end 740 of the arm 712 and the pillar 732 of the mounting bracket 710 (e.g., via insertion), the arm 712 is securely fastened to the mounting bracket 710 (and the vehicle body, e.g., see FIG. 1). However, to remove the arm 712, the locking pin 790 is simply withdrawn from (e.g., slid out of) the first end 740 of the arm 712 and the pillar 732 of the mounting bracket 710.

The pillar 732 of the mounting bracket 710 may define multiple pin channels (or bores) in a manner similar to that described above in connection with the example motorized fire hose winder 500. Such a feature enables the arm 712 to be aimed in different directions for winding different fire hoses without needed to re-orient the vehicle. Nevertheless, the arm 712 is richly and reliably secured to the mounting bracket 710 without risk of twisting via engagement of their rectangular cross-sections.

As another example, in some embodiments, the hardware 718 includes a locking pin 792 which locks the rotatable assembly 714 to the arm 712. Along these lines, the locking pin 792 may insert through the rotatable side member 750 to enable the rotatable side member 550 to be captured by the second end 742 of the arm 712 and rotate relative to the second end 742 of the arm 712.

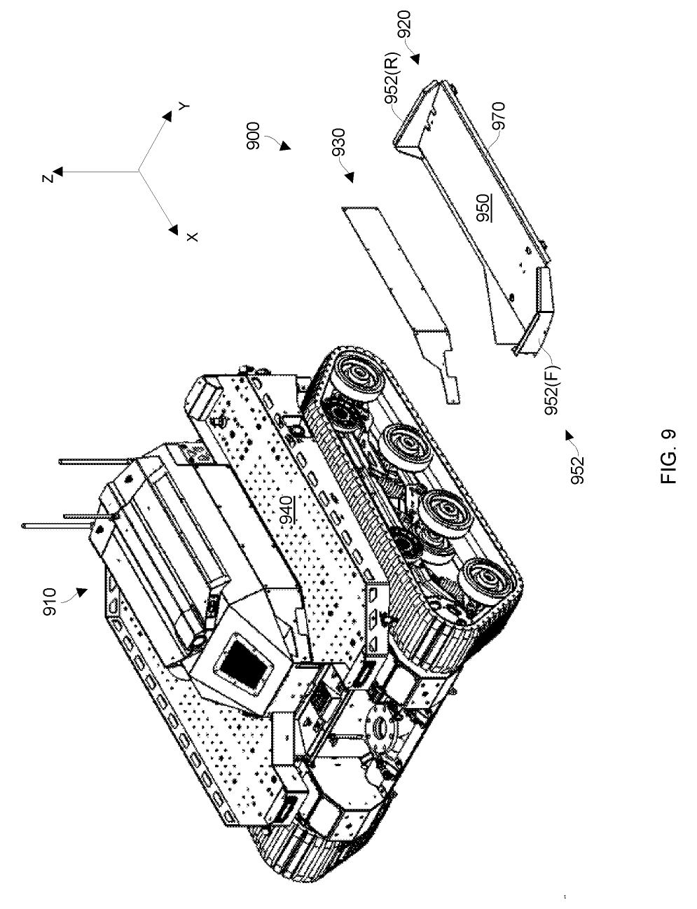

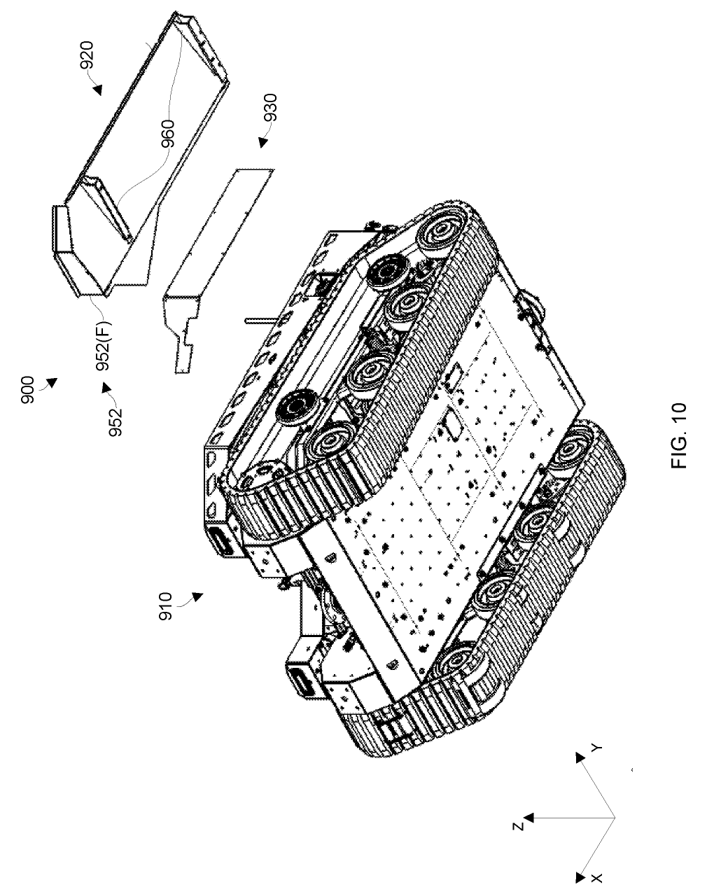

Other features similar to those of the example motorized fire hose winder 500 may be implemented on the example mechanical fire hose winder 700. For example, the hardware 718 may further include a locking pin which locks the rotatable side members 750, 752 together. Alternatively, the rotatable side members 750, 752 may be allowed to simply fit together without locking for convenience (e.g., easy removable of the side member 752 from the side member 750, and so on. Moreover, when using pins, such pins may be provided with grips or rings for easy grasping, springs for biasing/locking in place, etc. Further details will now be provided with reference to FIGS. 9 and 10.

FIGS. 9 and 10 show certain features of an example fire hose storage assembly 900 in accordance with one or more embodiments. FIG. 9 is an exploded view of the example fire hose storage assembly 900. FIG. 10 is a reverse angle exploded view of the example fire hose storage assembly 900. An example vehicle 910 is shown in FIGS. 9 and 10 to facilitate understanding/explanation.

The example fire hose storage assembly 900 is suitable for use as the fire hose storage assembly 140 described earlier as being mounted onto the robotic firefighting vehicle body 110 of the robotic firefighting vehicle 100 (e.g., also see FIGS. 1, 3, and 4). Along these lines, the example fire hose storage assembly 900 includes a hose storage tray 920 and a set of panels 930 (i.e., one or more panels 930).

In some arrangements, the hose storage tray 920 is integrated with at least one panel 930 (e.g., fabricated together, welded together, etc.). Such arrangements ensure proper placement of the components of the assembly 900 relative to each other and may enable simpler installation onto a vehicle body.

In other arrangements, the hose storage tray 920 and the set of panels 930 are separate from each other. Such arrangements enable less complex manufacturability as well as modularized installation (e.g., where perhaps one or more components of the hose storage tray 920 are omitted for customized usage, etc.).

The hose storage tray 920 is constructed and arranged to mount over a horizontal portion 940 of the vehicle 910. Along these lines, the body of the vehicle 910 may have an accessory mounting area, cargo basket to carry cargo, or similar feature 940 (FIG. 9) which is able to support the hose storage tray 920 and enable attachment of the hose storage tray 920 (e.g., via hardware).

As best seen in FIG. 9, the hose storage tray 920 provides (or includes) a sloped surface 950 on which a set of fire hoses may rest when the hose storage tray 920 is mounted over the horizontal portion 940 of the vehicle 910 and when the set of fire hoses is placed on the sloped surface 950. In particular, when the hose storage tray 920 is mounted over the horizontal portion 940, the sloped surface 950 slopes from a higher outer area of the vehicle 910 toward a lower inner area of the vehicle 910 (e.g., also see FIGS. 1 and 4).

In some arrangements, the hose storage tray 920 further provides (or includes) a set of side walls 952 along a set of lateral edges of the sloped surface 950. Along these lines, as best seen in FIG. 9, a forward side wall 952(F) disposed at a forward end of the hose storage tray, and a rear side wall 952(R) disposed at a rear end of the hose storage tray 920 which is opposite the forward end of the hose storage tray 920. The forward side wall 952(F) and the rear side wall 952(R) extend upwardly from the sloped surface 950 of the hose storage tray 920 (e.g., in the positive Z-direction). Accordingly, the set of side walls 952 enables any fire hoses resting on the sloped surface 950 from inadvertently sliding off the lateral edges of the sloped surface 950 (e.g., in the positive or negative X-direction).

As best seen in FIG. 10, the hose storage tray 920 further includes a set of supports 960 coupled with the sloped surface portion 950. The set of supports 960 is constructed and arranged to maintain the sloped surface portion 950 such that the sloped surface portion 950 slopes toward the vehicle 910 when the hose storage tray 920 is on the horizontal portion 940 (FIG. 9) of the vehicle 910. Additionally, in some arrangements, the set of supports 960 provides rigidity to the sloped surface portion 950 thus preventing inadvertent bending, sagging, deformation, etc.

As further shown in FIGS. 9 and 10, the fire hose storage assembly 900 includes a downward bent flange 970 disposed along an edge of the hose storage tray 920. The downward bent flange 970 (which may be an extension of the sloped surface portion 950) is constructed and arranged to extend out over a side of the horizontal portion of the vehicle 910 when the hose storage tray 920 is mounted over the horizontal portion of the vehicle 910 (e.g., also see the vehicle 100 in FIG. 1).

The set of panels 930 is constructed and arranged to mount over a set of portions of the vehicle 910 adjacent the horizontal portion of the vehicle 910. The set of panels 930 may flank (or border) the hose storage tray 920 when the hose storage tray 920 is mounted over the horizontal portion of the vehicle 910 and when the set of panels 930 is mounted over the set of portions of the vehicle 910 adjacent the horizontal portion of the vehicle 910.

In some arrangements, the hose storage tray 920 includes or is formed at least in part of stainless steel to prevent corrosion. Accordingly, the hose storage tray 920 will remain durable over time and not rust.

In some arrangements, the hose storage tray 920 and or one or more of the panels 930 fastens to the vehicle 910 via a plurality of bolts (e.g., also see FIG. 1). Accordingly, there are no sharp protrusions, etc. that could damage fire hoses resting on the fire hose storage assembly 900.

Other features are suitable for the fire hose storage assembly 900. For example, the hose storage tray 920 and/or one or more panels 930 may include drip holes to enable residual fluid to run off of the hose storage assembly 900. As another example, the hose storage tray 920 and/or one or more panels 930 may include bends, notches, gaps, etc. to properly cover portions of the vehicle, to enable access to parts of the vehicle behind and/or underneath, and so on.

As described above, a firefighting vehicle 100, 910 may be equipped with a fire hose winder 130, 500, 700 and/or a fire hose tray assembly 140, 900. Along these lines, such firefighting equipment may be installed on a robotic firefighting vehicle 100, 910 to facilitate fire hose management. In some arrangements, a fire hose winder 130, 500, 700 includes a rotatable assembly 514, 714 (e.g., a fire hose spindle or drum structure) that defines a fire hose space within which at least part of a fire hose is wound thus alleviating the need for complex and/or awkward fire hose coiling mechanisms (e.g., conventional mechanisms which require fire hoses to be fed through separate frontend hose guides before forming coils, conventional mechanisms which require careful attention as fire hoses are being coiled to avoid inadvertent unraveling during the coiling process, etc.). In some arrangements, a fire hose tray assembly 140, 900 mounts over a portion of a vehicle 100, 910 and provides an inwardly sloping surface 940 on which a wound fire hose may rest thus preventing the fire hose from damaging the vehicle 100, 910 (e.g., during placement of the fire hose onto the vehicle 100, 910), preventing the fire hose from falling off the vehicle and/or sustaining damage itself (e.g., while the vehicle is moving), and/or preventing damage to the fire hose (e.g., eliminating opportunities for snagging/catching as the fire hose is quickly removed from the vehicle for use), and so on.

While various embodiments of the present disclosure have been particularly shown and described, it will be understood by those skilled in the art that various changes in form and details may be made therein without departing from the spirit and scope of the present disclosure. Such modifications and enhancements are intended to belong to various embodiments of the disclosure.

It should be appreciated that certain prior methods involved stretching out a fire hose in a straight line, then bend down to the ground to grab one end of the roll and start to walk with the hose as you roll it up. This is inefficient and required a lot of physical input from the user to roll up the entire length of a hose and however many hoses they may have used.

In accordance with certain embodiments, a tool provides the user with the ability to quickly and efficiently roll up fire hoses after they are done being used. This reduces fatigue on the user and allows them to be more efficient. After a firefighter has been fighting a fire for hours on end, they must then clean up the scene, part of this includes rolling up hoses after use. Hoses are heavy and generally come in 50ft or 100ft lengths so it’s a tiring process to roll them up after being exhausted from fighting a fire. This invention aims to make that an easier process.

In accordance with certain embodiments, there is a rotatable assembly with a “fork” that retains one end of the hose while rolling the remaining hose around that end until there is a neatly wound hose roll. There is a handle with an additional set of forks that mates with forks on the rotatable assembly so when joined it locks the hose end into place. The handle being removable also allows for it to be taken off gaining the ability to slide the hose off the rotatable assembly and move to a storage area. This mounts to the robot with a standard bolting system that can be used on our robot, or the bumper of a fire truck among many other applications. There is a crank handle for manual operation or the option for an electric motor that winds with the flip of a switch, further reducing user effort input. On the manual version, there is also a storage spot for the crank handle (electric version does not have this).

In accordance with certain embodiments, a tool provides the user with the ability to quickly and efficiently roll up fire hoses after they are done being used. This reduces fatigue on the user and allows them to be more efficient.

In accordance with certain embodiments, there is a rotatable assembly with a “fork” that retains one end of the hose while rolling the remaining hose around that end until there is a neatly wound hose roll. This mounts to the robot with a standard bolting system that can be used on our robot, or the bumper of a fire truck among many other applications. There is a crank handle for manual operation or the option for an electric motor that winds with the flip of a switch, further reducing user effort input. On the manual version, there is also a storage spot for the crank handle (electric version does not have this).

Without the hose winder according to certain embodiments disclosed herein, the user would have to roll up fire hoses by hand which is tiring and time consuming. Such work is exactly what exhausted firefighters don’t want to deal with after fighting a fire for a long period of time.

Certain conventional hose winders on the market are very expensive, and some are limiting with size or mounting options. Certain apparatus disclosed herein aim to make a cost-effective manual option or a more convenient electric option, both solving the same goal.

Certain winding tool improvements disclosed herein are designed in such a way that will allow for them to be use on any of a family of vehicular robots. Such improvements may also be used on firefighting trucks.

In accordance with certain embodiments, the winding tool could easily be bolted to the bumper of a truck or in a fire station (or other stationary location) where it can be used to roll up hoses with minimal effort.

It should be further appreciated that rolls of hose could still be placed inside of the cargo basket of a robotic firefighting vehicle. However, the design of the cargo basket may not be wide enough for an entire roll of hose to sit down inside, especially when using larger hose. Because of this one end of the hose would rest up on the edge of the wall on the cargo basket and cause the fire hose to come un-rolled. In addition, over time the metal hose ends on the rolls could chip away at the finish on the robot and cause corrosion or cosmetic defects.

In accordance with certain embodiments, a hose storage tray is designed to sit within the confinements of the cargo basket on a robotic firefighting vehicle. The tray is of stainless-steel construction to prevent corrosion when hoses are tossed onto the tray (rather than the cargo basket which could potentially damage the paint). Since the large size of a rolled-up hose, it is also likely to come into contact with the side of the lid, therefore in some embodiments there is a protective stainless steel “skin” on the side of the lid as well. There may also be an inward slope on the tray that aims down towards the center of the robot to help prevent the rolls of hose from falling or rolling out of the side of the robot. There may also be small side walls on the ends of the tray to keep rolls in the tray and prevent them from sliding off onto the cargo basket.

In accordance with certain embodiments, there is a formed stainless-steel tray that covers the inside area of the cargo basket. This tray also has a slope to it that goes down towards the center of the vehicle. This slope extends out over the side of the cargo pod with a downward bent flange to cover the side wall of the cargo basket. This is to provide a smooth and snag free surface for hose to be slid on and off the tray quickly. There is a small wall on either side of the tray to keep any hoses or other objects within the protected surface of the tray. This tray is then bolted down to the cargo basket.

Additionally with the lid of the vehicle there are two “skins” that are riveted to the side to protect the paint on the lid so when rolls of hose are stacked up and lean against the side of the lid, it does not damage the paint.

Advantageously, certain improvements utilize an inward sloped tray to hold rolls of hose on the robot and help prevent them from rolling or falling out. Also such improvements serve the purpose of providing protection to the paint on the side of the lid and the cargo basket. Metal ends of the hose can otherwise chip paint when loading/unloading and cause corrosion and/or visual defects.

In accordance with certain embodiments, the tray has an inward slope to retain hose rolls, stainless steel construction for corrosion resistance, and end plates to hold hoses on the tray.

Without the hose tray, a roll of hose will not fit nicely in the cargo basket and is likely to come unrolled and require someone to reroll the hose. Conventionally, there is also no protection for the paint without the tray so it is possible that the paint can get chipped/damaged. Without the tray, the user would have to carry the hose themselves which are heavy and time consuming to move. However, with such a tray, the vehicle will do the hard work.

Such a tray may be used on a robotic firefighting vehicle. Along these lines, the vehicle may be a firefighting robot of any size.

In accordance with certain embodiments, such tray improvements can be used on any firefight application where protecting a finished surface is a goal. This also doesn’t have to be limited to just fire hoses and could be used for any type of hose or equipment that needs to be carried and could damage the finish on the product. Moreover, the geometries of the tray assembly may be modified to fit other applications.

In an example use case, an arm of the winding tool is oriented such that it points toward the front of the vehicle (e.g., overhangs at least a portion of the tray) to stow the winding tool while not in use. Then, via hardware (e.g., a pin), an operator is able to easily and quickly detach the arm and reattach the arm so that the arm points toward the back or off to the side for hose winding operation. Following such use, the arm is then re-oriented so that it points forward so that the arm and rotating components are not overhanging the side or the back of the vehicle.

The description herein provides examples for the purposes of understanding and is not intended to limit the invention or the application and uses of the same. Furthermore, there is no intention to be bound by any expressed or implied theory presented herein.

Directional references such as “top,” “bottom,” “left,” “right,” “above,” “below,” and so forth, unless otherwise stated, are not intended to require any preferred orientation and are made with reference to the orientation of the corresponding figure or figures for purposes of illustration.

It will be appreciated that the steps of various processes described herein are non-limiting examples of suitable processes according to embodiments and are for the purposes of illustration. Systems and devices according to embodiments herein may use any suitable processes including those that omit steps described above, perform those steps and similar steps in different orders, and the like. It will also be appreciated that well-known features may be omitted for clarity.

Certain embodiments are directed to a robotic firefighting vehicle which includes a robotic firefighting vehicle body constructed and arranged to robotically maneuver within an environment. The robotic firefighting vehicle further includes a fluid delivery system supported by the robotic firefighting vehicle body, the fluid delivery system being constructed and arranged to deliver fluid from a set of fire hoses to a set of targets. The robotic firefighting vehicle further includes a fire hose winder supported by the robotic firefighting vehicle body and/or a fire hose storage assembly supported by the robotic firefighting vehicle body.

Other embodiments are directed to a fire hose winder. Yet other embodiments are direct to a fire hose storage assembly.

Additionally, other embodiments are directed to various method such as methods for mounting, methods for assembling, methods for equipping, etc. Some embodiments are directed to provisioning a vehicle or structure with a fire hose winder and/or a fire hose storage assembly.

In accordance with one or more embodiments, the fire hose winder includes a mounting bracket constructed and arranged to mount to the robotic firefighting vehicle body, an arm having a first end constructed and arranged to couple with the mounting bracket and a second end opposite the first end, and a rotatable assembly. The rotatable assembly has:
(i) a first rotatable side member constructed and arranged to rotatably couple with the second end of the arm, and
(ii) a second rotatable side member constructed and arranged to engage with the first rotatable side member.

The first rotatable side member and the second rotatable side member define a hose space within which the fire hose is wound when the second rotatable side member engages with the first rotatable side member and when the first rotatable side member and the second rotatable side member rotate relative to the arm to wind the fire hose.

In accordance with one or more embodiments, the fire hose storage assembly includes a hose storage tray constructed and arranged to mount over a horizontal portion of the vehicle. The hose storage tray provides (or includes) a sloped surface on which the set of fire hoses rests when the hose storage tray is mounted over the horizontal portion of the vehicle and when the set of fire hoses is placed on the sloped surface provided by the hose storage tray. The sloped surface slopes from a higher outer area of the vehicle toward a lower inner area of the vehicle when the hose storage tray is mounted over the horizontal portion of the vehicle.

In accordance with one or more embodiments, the first rotatable side member of the rotatable assembly includes a first side section and a set of first posts extending from the first side section. Additionally, the second rotatable side member of the rotatable assembly includes a second side section and a set of second posts extending from the second side section. Furthermore, at least one first post and at least one second post are constructed and arranged to engage with each other and position the first side section and the second side section a predefined distance from each other to define the hose space.

In accordance with one or more embodiments, the first rotatable side member and the second rotatable side member rotate about an axis of rotation. Additionally, when the second rotatable side member engages with the first rotatable side member:
(i) each first post of the set of first posts extends from the first side section in a direction along the axis of rotation toward the second rotatable side member, and
(ii) each second post of the set of second posts extends from the second side section in a direction along the axis of rotation toward the first rotatable side member.

In accordance with one or more embodiments, the first rotatable side member and the second rotatable side member rotate about an axis of rotation. Additionally, the first rotatable side member includes exactly one first post which extends from the first side section and is coaxial with the axis of rotation. Furthermore, the second rotatable side member includes exactly two second posts.

In accordance with one or more embodiments, the first rotatable side member and the second rotatable side member rotate about an axis of rotation. Additionally, the first rotatable side member includes exactly two first posts disposed at equal radial distances in opposite directions from the axis of rotation. Furthermore, the second rotatable side member includes exactly two second posts disposed at equal radial distances in opposite directions from the axis of rotation.

In accordance with one or more embodiments, the mounting bracket includes a vehicle mounting plate constructed and arranged to mount to the vehicle and a pillar which extends outward from the mounting plate to engage the first end of the arm.

In accordance with one or more embodiments, the pillar of the mounting bracket has a rectangular cross-section. Additionally, the first end of the arm defines a hollow channel having rectangular cross-section to enable the first end of the arm to engage with the pillar of the mounting bracket.

In accordance with one or more embodiments, the fire hose winder further includes a locking pin constructed and arranged to insert through the pillar of the mounting bracket and the first end of the arm to lock the arm to the mounting bracket.

In accordance with one or more embodiments, the fire hose winder further includes a motor coupled with the arm and the rotatable assembly. The motor is constructed and arranged to rotate the rotatable assembly relative to the arm in response to electric power.

In accordance with one or more embodiments, the fire hose winder further includes a handle coupled with the rotatable assembly. The handle is constructed and arranged to rotate the rotatable assembly relative to the arm in response to mechanically applied force.

In accordance with one or more embodiments, a portion of the first rotatable side member is constructed and arranged to extend through the second end of the arm. Additionally, the fire hose winder further includes a locking pin constructed and arranged to insert through the portion of the first rotatable side member to lock the first rotatable side member to the second end of the arm.

In accordance with one or more embodiments, a portion of the first rotatable side member is constructed and arranged to extend through the second rotatable side member. Additionally, the fire hose winder further includes a locking pin constructed and arranged to insert through the portion of the first rotatable side member to lock the first rotatable side member to the second rotatable side member.

In accordance with one or more embodiments, the fire hose storage assembly further includes a forward side wall disposed at a forward end of the hose storage tray, and a rear side wall disposed at a rear end of the hose storage tray which is opposite the forward end of the hose storage tray. The forward side wall and the rear side wall extend upwardly from the hose storage tray to retain the set of fire hoses when the hose storage tray is mounted over the horizontal portion of the vehicle and when the set of fire hoses is placed on the sloped surface provided by the hose storage tray.

In accordance with one or more embodiments, the fire hose storage assembly further includes a downward bent flange disposed along an edge of the hose storage tray. The downward bent flange extends out over a side of the horizontal portion of the vehicle when the hose storage tray is mounted over the horizontal portion of the vehicle.

In accordance with one or more embodiments, the fire hose storage assembly further includes a plurality of bolts constructed and arranged to fasten the hose storage tray to the horizontal portion of the vehicle through a plurality of bolt holes defined by the hose storage tray.

In accordance with one or more embodiments, the hose storage tray includes stainless steel to prevent corrosion.

In accordance with one or more embodiments, the fire hose storage assembly further includes a set of panels constructed and arranged to mount over a set of portions of the vehicle adjacent the horizontal portion of the vehicle. The set of panels flanks the hose storage tray when the hose storage tray is mounted over the horizontal portion of the vehicle and when the set of panels is mounted over the set of portions of the vehicle adjacent the horizontal portion of the vehicle.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Further, although the term “user” as used herein may refer to a human being, the term is also intended to cover non-human entities, such as robots, bots, and other computer-implemented programs and technologies. Although certain embodiments are disclosed herein, it is understood that these are provided by way of example only and should not be construed as limiting.

Also, the foregoing description refers to elements or nodes or features being “connected” or “coupled” together. As used herein, unless expressly stated otherwise, “connected” means that one element is directly joined to (or directly communicates with) another element, and not necessarily mechanically. Likewise, unless expressly stated otherwise, “coupled” means that one element is directly or indirectly joined to (or directly or indirectly communicates with, electrically or otherwise) another element, and not necessarily mechanically. Thus, although the schematics and component features shown in the figures depict one exemplary arrangement of elements, additional intervening elements, devices, features, or components may be present in one or more other embodiments of the depicted subject matter.

Those skilled in the art will therefore understand that various changes in form and detail may be made to the embodiments disclosed herein without departing from the scope of the following claims.

What is claimed is:

1. A fire hose winder for a vehicle, the fire hose winder comprising:
a mounting bracket constructed and arranged to mount to the vehicle;
an arm having a first end constructed and arranged to couple with the mounting bracket and a second end opposite the first end; and
a rotatable assembly having:
a first rotatable side member constructed and arranged to rotatably couple with the second end of the arm, and
a second rotatable side member constructed and arranged to engage with the first rotatable side member, the first rotatable side member and the second rotatable side member defining a hose space within which the fire hose is wound when the second rotatable side member engages with the first rotatable side member and when the first rotatable side member and the second rotatable side member rotate relative to the arm to wind the fire hose.

2. The fire hose winder of claim 1, wherein the first rotatable side member of the rotatable assembly includes a first side section and a set of first posts extending from the first side section;
wherein the second rotatable side member of the rotatable assembly includes a second side section and a set of second posts extending from the second side section; and
wherein at least one first post and at least one second post are constructed and arranged to engage with each other and position the first side section and the second side section a predefined distance from each other to define the hose space.

3. The fire hose winder of claim 2, wherein the first rotatable side member and the second rotatable side member rotate about an axis of rotation;
wherein, when the second rotatable side member engages with the first rotatable side member:
each first post of the set of first posts extends from the first side section in a direction along the axis of rotation toward the second rotatable side member, and
each second post of the set of second posts extends from the second side section in a direction along the axis of rotation toward the first rotatable side member.

4. The fire hose winder of claim 2, wherein the first rotatable side member and the second rotatable side member rotate about an axis of rotation;
wherein the first rotatable side member includes exactly one first post which extends from the first side section and is coaxial with the axis of rotation; and
wherein the second rotatable side member includes exactly two second posts.

5. The fire hose winder of claim 2, wherein the first rotatable side member and the second rotatable side member rotate about an axis of rotation;
wherein the first rotatable side member includes exactly two first posts disposed at equal radial distances in opposite directions from the axis of rotation; and
wherein the second rotatable side member includes exactly two second posts disposed at equal radial distances in opposite directions from the axis of rotation.

6. The fire hose winder of claim 1, wherein the mounting bracket includes a vehicle mounting plate constructed and arranged to mount to the vehicle and a pillar which extends outward from the mounting plate to engage the first end of the arm.

7. The fire hose winder of claim 6, wherein the pillar of the mounting bracket has a rectangular cross-section; and
wherein the first end of the arm defines a hollow channel having rectangular cross-section to enable the first end of the arm to engage with the pillar of the mounting bracket.

8. The fire hose winder of claim 7, further comprising:
a locking pin constructed and arranged to insert through the pillar of the mounting bracket and the first end of the arm to lock the arm to the mounting bracket.

9. The fire hose winder of claim 1, further comprising:
a motor coupled with the arm and the rotatable assembly, the motor being constructed and arranged to rotate the rotatable assembly relative to the arm in response to electric power.

10. The fire hose winder of claim 1, further comprising:
a handle coupled with the rotatable assembly, the handle being constructed and arranged to rotate the rotatable assembly relative to the arm in response to mechanically applied force.

11. The fire hose winder of claim 1, wherein a portion of the first rotatable side member is constructed and arranged to extend through the second end of the arm; and
wherein the fire hose winder further comprises:
a locking pin constructed and arranged to insert through the portion of the first rotatable side member to lock the first rotatable side member to the second end of the arm.

12. The fire hose winder of claim 1, wherein a portion of the first rotatable side member is constructed and arranged to extend through the second rotatable side member; and
wherein the fire hose winder further comprises:
a locking pin constructed and arranged to insert through the portion of the first rotatable side member to lock the first rotatable side member to the second rotatable side member.

13. A robotic firefighting vehicle, comprising:
a robotic firefighting vehicle body constructed and arranged to robotically maneuver within an environment;
a fluid delivery system supported by the robotic firefighting vehicle body, the fluid delivery system being constructed and arranged to deliver fluid from a set of fire hoses to a set of targets; and
a fire hose winder as in claim 1, the fire hose winder being supported by the robotic firefighting vehicle body.

14. A fire hose storage assembly to store a set of fire hoses on a vehicle, the fire hose storage assembly comprising:
a hose storage tray constructed and arranged to mount over a horizontal portion of the vehicle, the hose storage tray providing a sloped surface on which the set of fire hoses rests when the hose storage tray is mounted over the horizontal portion of the vehicle and when the set of fire hoses is placed on the sloped surface provided by the hose storage tray, the sloped surface sloping from a higher outer area of the vehicle toward a lower inner area of the vehicle when the hose storage tray is mounted over the horizontal portion of the vehicle.

15. The fire hose storage assembly of claim 14, further comprising:
a forward side wall disposed on a forward end of the hose storage tray, and a rear side wall disposed on a rear end of the hose storage tray which is opposite the forward end of the hose storage tray, the forward side wall and the rear side wall extending upwardly from the hose storage tray to retain the set of fire hoses when the hose storage tray is mounted over the horizontal portion of the vehicle and when the set of fire hoses is placed on the sloped surface provided by the hose storage tray.

16. The fire hose storage assembly of claim 14, further comprising:
a downward bent flange disposed along an edge of the hose storage tray, the downward bent flange extending out over a side of the horizontal portion of the vehicle when the hose storage tray is mounted over the horizontal portion of the vehicle.

17. The fire hose storage assembly of claim 14, further comprising:
a set of panels constructed and arranged to mount over a set of portions of the vehicle adjacent the horizontal portion of the vehicle, the set of panels flanking the hose storage tray when the hose storage tray is mounted over the horizontal portion of the vehicle and when the set of panels is mounted over the set of portions of the vehicle adjacent the horizontal portion of the vehicle.

18. A robotic firefighting vehicle, comprising:
a robotic firefighting vehicle body constructed and arranged to robotically maneuver within an environment;
a fluid delivery system supported by the robotic firefighting vehicle body, the fluid delivery system being constructed and arranged to deliver fluid from a set of fire hoses to a set of targets; and
a fire hose storage assembly as in claim 14, the fire hose storage assembly being supported by the robotic firefighting vehicle body.

19. The robotic firefighting vehicle of claim 18, further comprising:
a cargo basket constructed and arranged to carry cargo, at least part of the cargo basket being the horizontal portion of the vehicle.

20. A robotic firefighting vehicle, comprising:
a robotic firefighting vehicle body constructed and arranged to robotically maneuver within an environment;
a fluid delivery system supported by the robotic firefighting vehicle body, the fluid delivery system being constructed and arranged to deliver fluid from a set of fire hoses to a set of targets;
a fire hose winder supported by the robotic firefighting vehicle body, the fire hose winder including a mounting bracket constructed and arranged to mount to the robotic firefighting vehicle body, an arm having a first end constructed and arranged to couple with the mounting bracket and a second end opposite the first end, and a rotatable assembly having:
a first rotatable side member constructed and arranged to rotatably couple with the second end of the arm, and
a second rotatable side member constructed and arranged to engage with the first rotatable side member, the first rotatable side member and the second rotatable side member defining a hose space within which the fire hose is wound when the second rotatable side member engages with the first rotatable side member and when the first rotatable side member and the second rotatable side member rotate relative to the arm to wind the fire hose; and
a fire hose storage assembly supported by the robotic firefighting vehicle body, the fire hose storage assembly including a hose storage tray constructed and arranged to mount over a horizontal portion of the vehicle, the hose storage tray providing a sloped surface on which the set of fire hoses rests when the hose storage tray is mounted over the horizontal portion of the vehicle and when the set of fire hoses is placed on the sloped surface provided by the hose storage tray, the sloped surface sloping from a higher outer area of the vehicle toward a lower inner area of the vehicle when the hose storage tray is mounted over the horizontal portion of the vehicle.
